(19) United States
(12) Patent Application Publication
(10) Pub. No.: US 2009/0129236 A1
(43) Pub. Date: May 21, 2009

(54) OPTICAL PICKUP DEVICE

(75) Inventor: Kenji Nagatomi, Kaizu-City (JP)

Correspondence Address: DITTHAVONG MORI & STEINER, P.C., 918 Prince St., Alexandria, VA, 22314, US

(73) Assignee: Sanyo Electric Co., Ltd., Moriguchi-shi (JP)

(21) Appl. No.: 12/273,631

(22) Filed: Nov. 19, 2008

(30) Foreign Application Priority Data
Nov. 20, 2007 (JP) 2007-301050

(51) Int. Cl. G11B 7/135

(52) U.S. Cl. 369/112.03; G9B/7.112

(57) ABSTRACT

An optical pickup device includes a diffraction grating for separating laser light into a main beam and two sub beams, a photodetector having a sensor pattern for receiving the main beam and the sub beams reflected on a recording medium having multiple laminated recording layers respectively individually, and a diffraction element for positioning the main beam and the sub beams reflected on a targeted recording layer to be irradiated on the sensor pattern, and diffracting the main beam and the sub beams reflected on a recording layer other than the targeted recording layer to be irradiated in such a manner that the main beam and the sub beams are not overlapped with each other on the sensor pattern.

This application claims priority under 35 U.S.C. Section 119 of Japanese Patent Application No. 2007-301050 filed on Nov. 20, 2007, entitled “OPTICAL PICKUP DEVICE.”

### BACKGROUND OF THE INVENTION

1. Field of the Invention

The present invention relates to an optical pickup device, and more particularly to an arrangement suitable for recording and reproducing on and from a recording medium having multiple recording layers in a laminated direction.

2. Disclosure of Related Art

In recent years, as the technology of increasing the capacity of a recording medium has been developed, an optical recording medium having multiple recording layers in a laminated direction has been developed. In the case where a recording/reproducing operation is performed with respect to the optical recording medium, laser light from an optical pickup device is converged on a targeted recording layer to be recorded/reproduced, and various servo signals (such as a focus servo signal and a tracking servo signal) are generated based on reflection light from the targeted recording layer.

In the case where the recording medium has multiple recording layers as described above, there occurs a drawback that reflection light (stray light) from a recording layer other than the targeted recording layer to be recorded/reproduced may be incident onto a photodetector, and the light incidence may degrade the signal quality. In particular, in an optical pickup device using a three-beam method, stray light is incident onto a sensor pattern which is designed to receive a sub beam whose light intensity is very low. As a result, an output signal from the sensor pattern is likely to vary. In view of the above, it is necessary to provide an effective measure against stray light resulting from a sub beam in the optical pickup device using the three-beam method.

One of the influences of stray light resulting from a sub beam may be an influence of an interference fringe. In an optical pickup device using a three-beam method, stray light is generated with respect to each of a main beam and two sub beams. If the stray light is simultaneously irradiated onto a sensor pattern, the stray light may interfere with each other. As a result, an interference fringe whose intensity is cyclically changed is formed on the sensor pattern. The interference fringe moves on the sensor pattern depending on a surface variation or the like of a recording medium. Consequently, in performing a recording/reproducing operation, an output signal from the sensor pattern for receiving a sub beam may be dynamically changed depending on the movement of the interference fringe.

The above drawback may be eliminated by using an approach shown in FIGS. 9A and 9B. FIG. 9A is a diagram showing an arrangement example of an optical pickup device for use in the above approach. 11 indicates a semiconductor laser, 12 indicates a diffraction grating, 13 indicates a collimator lens, 14 indicates a beam splitter, 15 indicates an objective lens, 16 indicates a light blocking member having a light blocking portion 16a, 17 indicates a condenser lens, and 18 indicates a photodetector.

In the above arrangement example, the light blocking member 16 is provided on an optical path of laser light, and the light blocking portion 16a formed on the light blocking member 16 blocks incidence of stray light. In this arrangement, states of a main beam spot and sub beam spots, and an irradiation state of stray light on a light receiving plane of the photodetector 18 are respectively as shown in FIGS. 9B and 9C.

As shown in FIG. 9C, the arrangement example enables to block incidence of stray light onto sensors 1, 2, and 3. However, since a part of signal light reflected on a targeted recording layer is also blocked by the light blocking portion 16a, as shown in FIG. 9B, an area (light blocking area) devoid of reflection light may be formed within the main beam spot and the sub beam spots on the light receiving planes of the sensors 1, 2, and 3. In this case, particularly, loss of signal light within the main beam spot is a serious drawback. Specifically, since signal light is lost in a central part of the beam spot where the light intensity is high, there occurs a drawback that the quality of a reproduction RF signal or a focus error signal may be significantly degraded.

In recent years, BD (blu-ray disc) and HDDVD (High-Definition Digital Versatile Disc, hereinafter, called as “HD”) have been commercialized as next-generation high-density optical discs. It is also possible to form multiple recording layers in these optical discs. Accordingly, these optical discs may encounter the aforementioned drawback concerning stray light.

In the case where an optical pickup device is compatible with both of BD and HD, a single laser light source may be used in common between BD and HD, because the wavelength bands to be used in BD and HD are identical to each other. However, the thickness of a cover layer greatly differs between BD and HD. Accordingly, generally, two objective lenses having numerical apertures corresponding to BD and HD are individually provided in the currently available optical pickup devices. Concerning the arrangement of a light receiving portion for receiving reflection light from a disc, a single light receiving portion may be used in common between BD and HD, or light receiving portions may be individually formed for BD and HD. In the latter case, it is necessary to provide an arrangement for separating an optical path of laser light reflected on BD and an optical path of laser light reflected on HD to individually guide the two laser light to the respective corresponding light receiving portions (sensor patterns).

### SUMMARY OF THE INVENTION

An object of the invention is to provide an arrangement that enables to effectively suppress a drawback by an interference fringe resulting from stray light, with no or less likelihood that light may be lost in a beam spot.

An optical pickup device according to a first aspect of the invention includes: a light source for emitting laser light; a diffraction grating for separating the laser light into a main beam and two sub beams; an objective lens for irradiating the main beam and the sub beams onto a recording medium having multiple laminated recording layers; a photodetector having a sensor pattern for receiving the main beam and the sub beams reflected on the recording medium respectively individually; and a diffraction element for positioning the main beam and the sub beams reflected on a targeted recording layer to be irradiated on the sensor pattern, and diffracting the main beam and the sub beams reflected on a recording layer other than the targeted recording layer to be irradiated in such a manner that the main beam and the sub beams are not overlapped with each other on the sensor pattern.

An optical pickup device according to a second aspect of the invention includes: a light source for emitting laser light; a diffraction grating for separating the laser light into a main beam and two sub beams; a polarized beam splitter for separating an optical path of the main beam and the sub beams into an optical path of a first main beam and a first sub beam having a first polarization direction, and an optical path of a second main beam and a second sub beam having a second polarization direction orthogonal to the first polarization direction; a first objective lens for irradiating the first main beam and the first sub beam onto a first recording medium having multiple laminated recording layers; a second objective lens for irradiating the second main beam and the second sub beam onto a second recording medium; a first photodetector having a first sensor pattern for receiving the first main beam and the first sub beam reflected on the first recording medium respectively individually; a second photodetector having a second sensor pattern displaced in a direction parallel to a light receiving plane of the first sensor pattern, and adapted for receiving the second main beam and the second sub beam reflected on the second recording medium respectively individually; and a diffraction element having a polarization dependency and adapted for making propagating directions of the first main beam and the first sub beam different from propagating directions of the second main beam and the second sub beam in such manner that the first main beam and the first sub beam are received on the first sensor pattern, and the second main beam and the second sub beam are received on the second sensor pattern, wherein the diffraction element is configured in such a manner that the first main beam and the first sub beam reflected on a targeted recording layer to be irradiated of the recording layers of the first recording medium are positioned on the first sensor pattern, and the first main beam and the first sub beam reflected on a recording layer other than the targeted recording layer to be irradiated are not overlapped with each other on the first sensor pattern.

### BRIEF DESCRIPTION OF THE DRAWINGS

These and other objects, and novel features of the present invention will become more apparent upon reading the following detailed description along with the accompanying drawings.

FIGS. 1A and 1B are diagrams showing an optical system in an optical pickup device in accordance with an embodiment of the invention.

FIGS. 2A and 2B are diagrams showing an arrangement of a polarization diffraction element in accordance with the embodiment.

FIGS. 3A through 3D are diagrams showing a relation between a sensor pattern and a beam in accordance with the embodiment.

FIGS. 4A through 4C are diagrams showing a relation between a sensor pattern and stray light in accordance with the embodiment.

FIGS. 5A through 5C are diagram showing a relation between a sensor pattern and stray light as a modification of the embodiment.

FIGS. 6A and 6B are diagrams showing an arrangement of a polarization diffraction element as a modification of the embodiment.

FIGS. 7A and 7B are diagrams showing an arrangement and an operation of a polarization diffraction element as another modification of the embodiment.

FIGS. 8A and 8B are diagrams showing an arrangement and an operation of a polarization diffraction element as yet another modification of the embodiment.

FIGS. 9A through 9C are diagrams for describing the related art.

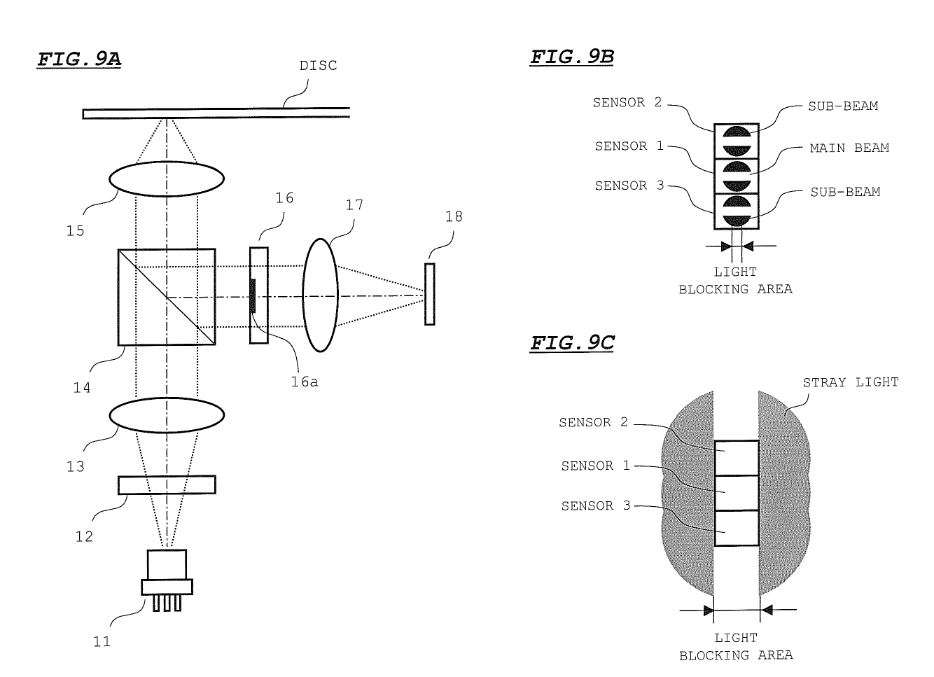

The drawings are provided mainly for describing the present invention, and do not limit the scope of the present invention.

### DESCRIPTION OF PREFERRED EMBODIMENTS

In the following, an embodiment of the invention is described referring to the drawings. The embodiment is directed to a reproduction-only optical pickup device compatible with HD whose cover layer thickness is 0.6 mm, and BD (blu-ray disc) whose cover layer thickness is 0.1 mm, to which the invention is applied. Both of HD and BD in the embodiment are a multilayered disc having multiple recording layers in a laminated direction.

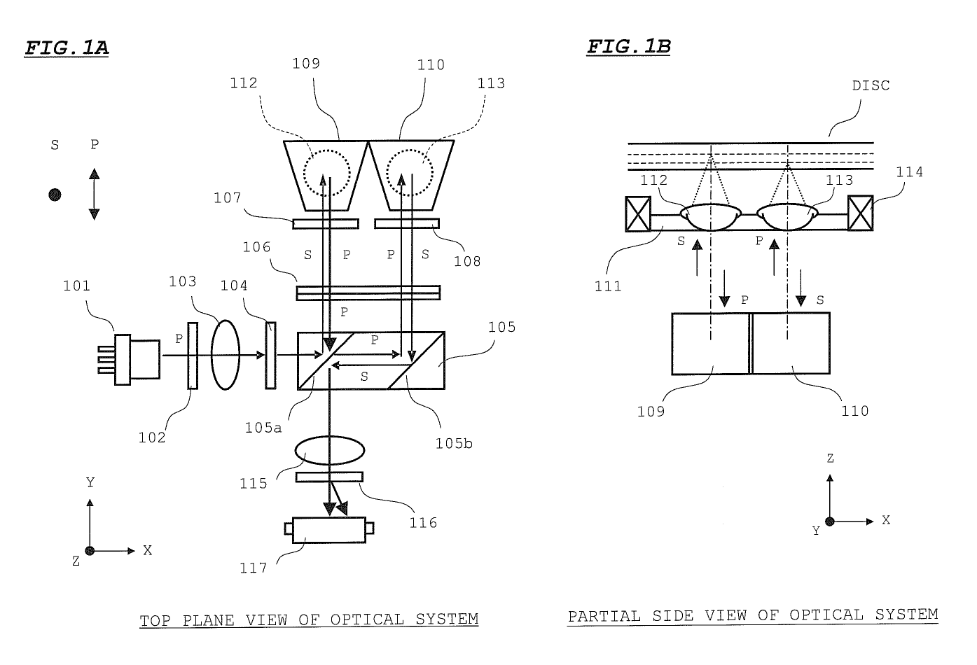

FIGS. 1A and 1B are diagrams showing an optical system in the optical pickup device in accordance with the embodiment of the invention. FIG. 1A is a plan view of the optical system excluding an optical element posterior to rise-up mirrors 109 and 110. FIG. 1B is a side view of the optical system posterior to the rise-up mirrors 109 and 110. In FIG. 1B, the optical system is illustrated in a state that an HD objective lens 112, and a BD objective lens 113 are viewed in perspective.

As shown in FIGS. 1A and 1B, the optical system in the optical pickup device includes a semiconductor laser 101, a diffraction grating 102, a collimator lens 103, a polarization rotating element 104, a spectral mirror 105, a liquid crystal device 106, quarter wavelength plates 107 and 108, the rise-up mirrors 109 and 110, a holder 111, the HD objective lens 112, the BD objective lens 113, an objective lens actuator 114, an anamorphic lens 115, a polarization diffraction element 116, and a photodetector 117.

The semiconductor laser 101 emits laser light of a blue wavelength (about 400 nm). The diffraction grating 102 separates the laser light emitted from the semiconductor laser 101 into a main beam and two sub beams. The collimator lens 103 converts the laser light transmitted through the diffraction grating 102 into parallel light.

The polarization rotating element 104 changes the polarization direction of laser light in accordance with a control signal. Specifically, the polarization rotating element 104 converts laser light so that the polarization direction of laser light is aligned with the direction of S-polarized light with respect to a polarized mirror surface 105a in recording and reproducing on and from HD; and converts laser light so that the polarization direction of laser light is aligned with the direction of P-polarized light with respect to the polarized mirror surface 105a in recording and reproducing on and from BD. Alternatively, the polarization rotating element 104 may be operable to rotate a half wavelength plate about an optical axis of laser light in accordance with a control signal, or move a half wavelength plate on and away from an optical path of laser light in accordance with a control signal. Further alternatively, it is possible to employ an arrangement for changing a polarization characteristic by a photoelectric effect to be obtained in applying a voltage to an optical crystal, or a liquid crystal element or a like device may be used.

The spectral mirror 105 is made of a light transmissive material, and is internally provided with the polarized mirror surface 105a and a mirror surface 105b. The spectral mirror 105 has a rectangular parallelepiped shape, and is arranged at such a position that a surface thereof opposing to the polarization rotating element 104 and a surface thereof opposing to the liquid crystal device 106 respectively intersect perpendicularly to an optical axis (X-axis in FIG. 1A) of laser light to be emitted from the semiconductor laser 101 and an axis (Y-axis in FIG. 1A) perpendicular to X-axis. The polarized mirror surface 105a and the mirror surface 105b are respectively tilted with respect to the optical axis of laser light to be emitted from the semiconductor laser 101 by 45°.

In the case where the polarization direction of laser light to be incident from the polarization rotating element 104 onto the spectral mirror 105 is aligned with the direction of S-polarized light with respect to the polarized mirror surface 105a, the laser light is reflected in Y-axis direction by the polarized mirror surface 105a. On the other hand, in the case where the polarization direction of laser light to be incident onto the spectral mirror 105 is aligned with the direction of P-polarized light with respect to the polarized mirror surface 105a, the laser light is transmitted through the polarized mirror surface 105a, and reflected in Y-axis direction by the mirror surface 105b.

The liquid crystal device 106 is operable to change a wavefront state of laser light in accordance with a control signal, and correct aberration of laser light on HD, BD, and the photodetector 117. The aberration correction (spherical aberration correction) using a liquid crystal element is recited in e.g. Japanese Unexamined Patent Publication No. Hei 10-269611.

In the arrangement example shown in FIGS. 1A and 1B, the polarization direction of laser light (incident laser light) to be incident from the spectral mirror 105 onto the liquid crystal device 106 intersects perpendicularly to the polarization direction of laser light (reflection laser light) to be incident from the quarter wavelength plate 107, 108 to the liquid crystal device 106 by the function of the quarter wavelength plate 107, 108. In view of this, the liquid crystal device 106 is formed by placing a liquid crystal element for incident laser light, and a liquid crystal element for reflection laser light one over the other.

The polarization direction of laser light (incident laser light for HD) directed from the polarized mirror surface 105a toward the quarter wavelength plate 107 is aligned with the polarization direction of laser light (reflection laser light for BD) directed from the quarter wavelength plate 108 toward the mirror surface 105b; and the polarization direction of laser light (reflection laser light for HD) directed from the quarter wavelength plate 107 toward the polarized mirror surface 105a is aligned with the polarization direction of laser light (incident laser light for BD) directed from the mirror surface 105b toward the quarter wavelength plate 108. In this arrangement, assuming that out of the two liquid crystal elements constituting the liquid crystal device 106, the first liquid crystal element is used for incident laser light for HD, and the second liquid crystal element is used for reflection laser light for HD, the first liquid crystal element is used to correct aberration with respect to reflection laser light for BD, and the second liquid crystal element is used to correct aberration with respect to incident laser light for BD.

The quarter wavelength plate 107 converts laser light (laser light for HD) reflected on the polarized mirror surface 105a into circularly polarized light, and converts reflection light from a disc into linearly polarized light whose polarization direction intersects perpendicularly to the polarization direction of laser light to be incident onto the disc. Thereby, the laser light for HD reflected on the disc is converted into P-polarized light with respect to the polarized mirror surface 105a, and guided to the photodetector 117 through the polarized mirror surface 105a.

The quarter wavelength plate 108 converts laser light (laser light for BD) reflected on the mirror surface 105b into circularly polarized light, and converts reflection light from a disc into linearly polarized light whose polarization direction intersects perpendicularly to the polarization direction of laser light to be incident onto the disc. Thereby, the laser light for BD reflected on the disc is converted into S-polarized light with respect to the polarized mirror surface 105a, reflected on the polarized mirror surface 105a, and guided to the photodetector 117.

The rise-up mirror 109, 110 reflects laser light for HD, laser light for BD, which has been converted into circularly polarized light by the quarter wavelength plate 107, 108 in the arranged direction of the HD objective lens 112, the BD objective lens 113 (Z-axis direction in FIG. 1A).

The holder 111 integrally holds the HD objective lens 112 and the BD objective lens 113. The HD objective lens 112 is designed in such a manner that laser light of a blue wavelength is properly converged on HD of 0.6 mm in substrate thickness. The BD objective lens 113 is designed in such a manner that laser light of a blue wavelength is properly converged on BD of 0.1 mm in substrate thickness.

The objective lens actuator 114 drives the holder 111 in focusing direction and tracking direction in accordance with a servo signal. Thereby, the HD objective lens 112 and the BD objective lens 113 are integrally driven in focusing direction and tracking direction. The objective lens actuator 114 is e.g. a well-known electromagnetic driven actuator.

The anamorphic lens 115 converges laser light reflected on the disc onto the photodetector 117. The anamorphic lens 115 is constituted of a condenser lens and a cylindrical lens, and introduces astigmatism to reflection light from the disc.

The polarization diffraction element 116 is configured in such a manner that the polarization diffraction element 116 is operable to diffract solely the laser light (S-polarized light) reflected on the polarized mirror surface 105a, and is inoperable to diffract the laser light (P-polarized light) transmitted through the polarized mirror surface 105a.

In the above arrangement, out of HD laser light (P-polarized light) and BD laser light (S-polarized light) incident onto the polarization diffraction element 116, the polarization diffraction element 116 is operable to diffract solely the BD laser light (S-polarized light). Thereby, the HD laser light and the BD laser light are separated from each other. The HD laser light and the BD laser light separated as described above are individually received on two sensor patterns formed on the photodetector 117. The arrangement of the polarization diffraction element 116 is described later in detail.

The photodetector 117 has a sensor pattern for deriving a reproduction RF signal, a focus error signal, and a tracking error signal based on an intensity distribution of received laser light.

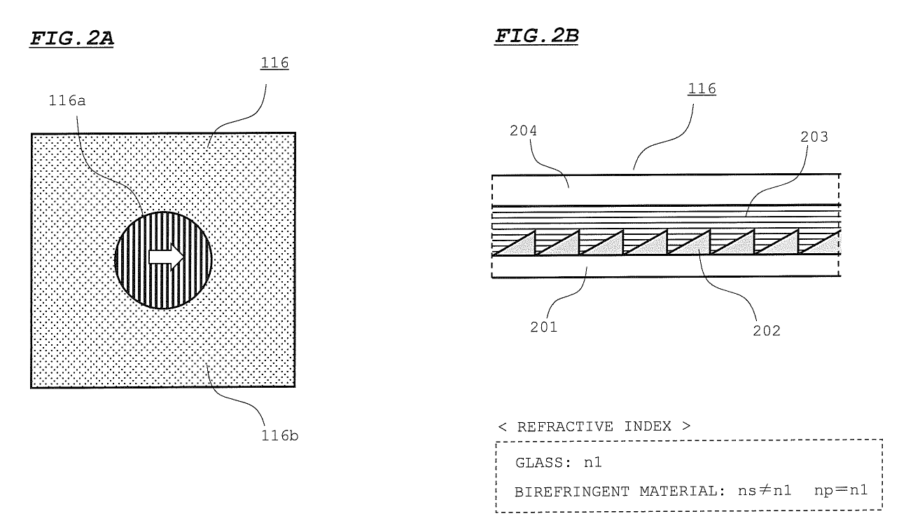

FIGS. 2A and 2B are diagrams showing an arrangement of the polarization diffraction element 116. FIG. 2A is a plan view of the polarization diffraction element 116. FIG. 2B is a diagram showing a sectional structure of a part of a diffraction area 116a taken along in thickness direction of the diffraction area 116a in FIG. 2A.

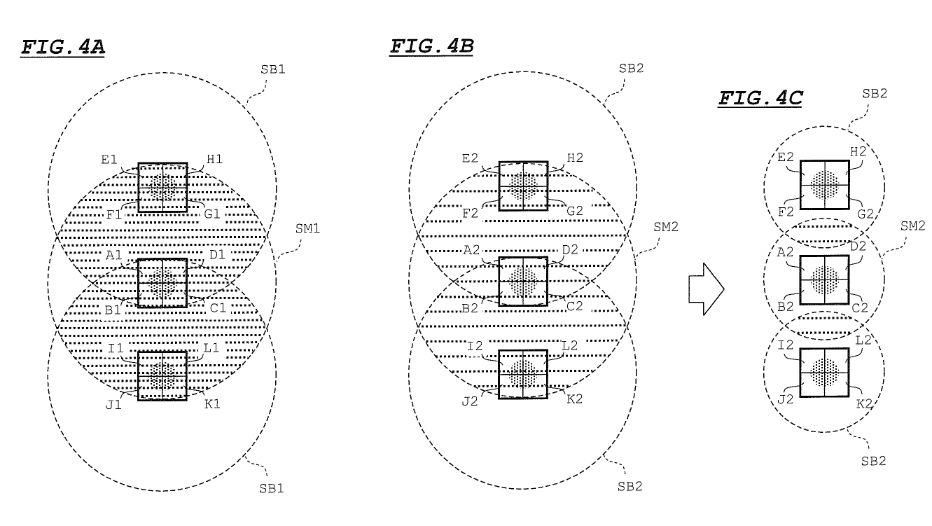

As shown in FIG. 2A, the polarization diffraction element 116 has the diffraction area 116a operable to diffract solely the S-polarized laser light, and an outer peripheral area (transparent area) 116b inoperable to diffract the S-polarized laser light and the P-polarized laser light. Optical axes of HD laser light and BD laser light are aligned with a center of the polarization diffraction element 116, and inner peripheral parts of the HD laser light and the BD laser light are incident onto the diffraction area 116a. In this arrangement, solely the inner peripheral part of the BD laser light (S-polarized light) is diffracted by the diffraction area 116a, and the propagating direction thereof is changed, whereas the outer peripheral parts of the BD laser light (S-polarized light) and the HD laser light (P-polarized light) are not diffracted, and are propagated through the polarization diffraction element 116. A manner as to how the diffraction area 116a is defined is described later referring to FIGS. 4A through 4C.

As shown in FIG. 2B, the diffraction area 116a is obtained by forming a blazed diffraction structure 202 made of a birefringent material on a transparent substrate 201, and forming a glass layer 203 and a transparent substrate 204 on the blazed diffraction structure 202. The blazed diffraction structure 202 is obtained by forming a sawtoothed hologram of a predetermined height at a predetermined pitch.

The refractive index of the blazed diffraction structure 202 is defined to satisfy: np=n1, ns≠n1, where np is a refractive index of the blazed diffraction structure in the case where laser light is P-polarized light, ns is a refractive index of the blazed diffraction structure in the case where laser light is S-polarized light, and n1 is a refractive index of glass. In this arrangement, in the case where laser light is incident onto the polarization diffraction element 116 as P-polarized light, there is no difference between the refractive index (np) of the blazed diffraction structure 202 and the refractive index (n1) of glass. In this state, the blazed diffraction structure 202 does not function as a diffraction grating. On the other hand, in the case where laser light is incident onto the polarization diffraction element 116 as S-polarized light, there is a difference between the refractive index (ns) of the blazed diffraction structure 202 and the refractive index (n1) of glass. In this state, the blazed diffraction structure 202 functions as a diffraction grating.

An example of the principle on a polarization diffraction element made of a birefringent material is described in Japanese Unexamined Patent Publication No. 2002-365416.

The polarization diffraction element 116 shown in FIGS. 2A and 2B is configured in such a manner that laser light is diffracted by the blazed diffraction structure. Accordingly, the polarization diffraction element 116 is operable to diffract solely the plus 1-order laser light or the minus 1-order laser light. This is advantageous in enhancing the diffraction efficiency of laser light.

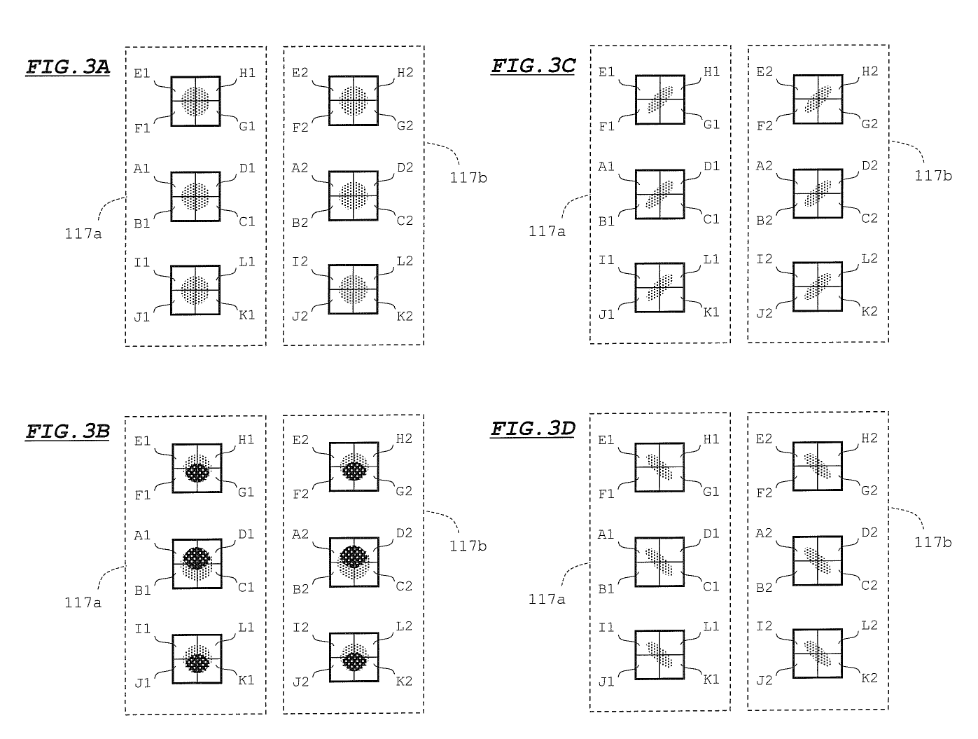

FIGS. 3A through 3D are diagrams showing sensor patterns on the photodetector 117. In this embodiment, a differential push-pull method is used as a method for generating a tracking error signal, and a differential astigmatism method is used as a method for generating a focus error signal. In FIGS. 3A through 3D, convergence spots of laser light (signal light) reflected on a targeted recording layer to be recorded/reproduced is indicated by hatched portions.

In FIGS. 3A through 3D, 117a indicates an HD sensor pattern for receiving HD laser light, and 117b indicates a BD sensor pattern for receiving BD laser light. As shown in FIGS. 3A through 3D, three four-divided sensors are arrayed in a row in each of the sensor patterns. Specifically, out of three laser beams separated through the diffraction grating 102, a main beam is received on a middle four-divided sensor, and two sub beams are received on an upper four-divided sensor and a lower four-divided sensor, respectively.

Assuming that sensing portions of the three four-divided sensors constituting the HD sensor pattern 117a are indicated, as shown in FIGS. 3A through 3D, by the symbols A1, B1, C1, D1, E1, F1, G1, H1, I1, J1, K1, and L1; and detection outputs from the sensing portions A1 through L1 are indicated by the symbols PA1, PB1, PC1, PD1, PE1, PF1, PG1, PH1, PI1, PJ1, PK1, and PL1, a differential push-pull signal (DPP) is given by the following equation (1).

DPP={(PA1+PD1)−(PB1+PC1)}−k1·{(PE1+PH1+PI1+PL1)−(PF1+PG1+PJ1+PK1)} (1)

In the above equation, the coefficient k1 is an adjusting coefficient for making the detection output of the main beam equal to the sum of detection outputs of the two sub beams.

In the case where the main beam is properly condensed on a targeted track on HD, the states of the main beam spot and the two sub beam spots on the HD sensor pattern 117a are as shown in FIG. 3A. In this state, each of the light intensity distributions of the main beam spot and the sub beam spots is symmetrical with respect to a dividing line of the four-divided sensors. Accordingly, as a result of computation in accordance with the equation (1), the differential push-pull signal (DPP) is: DPP=0.

If tracking displacement of the main beam occurs in the above state, the states of the main beam spot and the two sub beam spots on the HD sensor pattern 117a are as shown in FIG. 3B. In FIGS. 3A through 3D, the light intensity distribution is schematically illustrated within each of the beam spots, wherein the density of a hatched portion is increased, as the light intensity is increased.

In the state shown in FIG. 3B, the light intensity distributions considering the track diffraction of the main beam and the two sub beams on the light receiving plane are displaced in a direction based on tracking displacement. As is obvious from FIG. 3B, the light intensity distribution within each of the beam spots of the two sub beams is displaced in a direction opposite to the direction of tracking displacement of the main beam. Accordingly, as a result of computation in accordance with the equation (1), the differential push-pull signal (DPP) has a positive or a negative value. Thus, tracking displacement of the main beam on the disc can be detected based on the value of the differential push-pull signal (DPP).

Use of the differential push-pull method enables to cancel a DC offset in a push-pull signal resulting from tilt of a disc, disagreement of optical axes of the objective lenses, or a like factor by the computation in accordance with the equation (1), even if the DC offset occurs. This is advantageous in enhancing precision in detecting tracking displacement.

Similarly to the above, a differential astigmatism signal (DAS) for use in detecting a focus error is given by the following equation (2), assuming that detection outputs from the sensing portions A1 through L1 are indicated by the symbols PA1 through PL1, respectively:

DAS={(PA1+PC1)−(PB1+PD1)}−k2·{(PE1+PG1+PI1+PK1)−(PF1+PH1+PJ1+PL1)} (2)

where k2 is a coefficient having the same meaning as the coefficient k1.

In an on-focus state shown in FIG. 3A, the shapes of the main beam spot and the sub beam spots on the light receiving plane of the HD sensor pattern 117a are a substantially perfect circle. Accordingly, as a result of computation in accordance with the equation (2), the differential astigmatism signal (DAS) is: DAS=0.

On the other hand, if the focus position of the main beam is displaced in forward or backward direction with respect to a recording plane, the shapes of the main beam spot and the two sub beam spots are changed into an elliptical shape depending on the direction of focus displacement, as shown in FIG. 3C or 3D. In this state, as a result of computation in accordance with the equation (2), the differential astigmatism signal (DAS) has a negative value (in the case of FIG. 3C), or a positive value (in the case of FIG. 3D). Thereby, focus displacement of the main beam on the recording plane of the disc can be detected based on the value of the differential astigmatism signal (DAS).

In the foregoing, an approach for generating a tracking error signal and a focus error signal has been described by taking an example of an output signal from the HD sensor pattern 117a. Alternatively, a tracking error signal (differential push-pull signal) for BD, and a focus error signal (differential astigmatism signal) for BD may be generated by computing an output signal from the BD sensor pattern 117b in the similar manner as described above.

Next, a state of stray light on a sensor pattern is described referring to FIGS. 4A through 4C.

FIG. 4A is a diagram schematically showing an irradiation state of stray light on the HD sensor pattern 117a. As already described referring to FIGS. 2A and 2B, HD laser light is propagated to the HD sensor pattern 117a through the polarization diffraction element 116 without being diffracted by the polarization diffraction element 116.

Accordingly, HD laser light (stray light) reflected on a recording layer (hereinafter, called as “adjacent recording layer”) adjacent to a targeted recording layer to be recorded/reproduced in a laminated direction is also propagated to the HD sensor pattern 117a without being diffracted by the polarization diffraction element 116. In FIG. 4A, a circular spot SM1 indicates an irradiation area of a main beam reflected on an adjacent recording layer, and two circular spots SB1 indicate irradiation areas of two sub beams, respectively.

In the above state, as shown in FIG. 4A, the main beam spot SM1, and the sub beam spots SB1 are overlapped with each other on the four-divided sensors. As a result, stray light resulting from the main beam and the sub beams is interfered with each other, and an interference fringe is formed on each of the four-divided sensors. In FIG. 4A, an interference fringe is indicated by the straight dotted lines.

FIG. 4B is a diagram schematically showing an irradiation state of stray light on the BD sensor pattern 117b, in the case where a diffraction structure is formed on the entire area of the polarization diffraction element 116. In this case, not only an inner peripheral part of BD laser light (stray light) reflected on an adjacent recording layer of BD but also an outer peripheral part thereof are diffracted by the polarization diffraction element 116, and the diffracted light is irradiated onto the BD sensor pattern 117b. In FIG. 4B, a circular spot SM2 indicates an irradiation area of a main beam reflected on an adjacent recording layer, and two circular spots SB2 indicate irradiation areas of two sub beams, respectively.

In the above case, similarly to the case of FIG. 4A, the main beam spot SM2 and the sub beam spots SB2 are overlapped with each other on each of the four-divided sensors. As a result, stray light resulting from the main beam and the sub beams is interfered with each other, and an interference fringe is formed on each of the four-divided sensors. In FIG. 4B, an interference fringe is indicated by the straight dotted lines.

On the other hand, in the embodiment, as shown in FIG. 2A, the diffraction structure is formed solely on the diffraction area 116a. Accordingly, a main beam (stray light) and sub beams (stray light) reflected on an adjacent recording layer are guided to the BD sensor pattern 117b in a state that solely the inner peripheral parts thereof are diffracted by the diffraction area 116a corresponding to the inner peripheral area of the polarization diffraction element 116. As a result, the irradiation states of the main beam (stray light) and the sub beams (stray light) on the BD sensor pattern 117b are as shown in FIG. 4C.

In the above arrangement, since the main beam spot SM2 and the sub beam spots SB2 are not overlapped with each other on each of the four-divided sensors, there is no likelihood that an interference fringe may be formed on the four-divided sensors. In FIG. 4C, an interference fringe is indicated by the straight dotted lines. This arrangement enables to obtain an intended servo signal and an intended reproduction RF signal, without likelihood that an output signal from each of the four-divided sensors may be interfered by an interference fringe.

As shown in FIG. 4C, the diffraction area 116a shown in FIG. 2A is an area operable to guide a main beam (signal light) and sub beams (signal light) from a targeted recording layer to be recorded/reproduced to the BD sensor pattern 117b, and keep a main beam (stray light) and sub beams (stray light) reflected on an adjacent recording layer from being overlapped with each other on the four-divided sensors.

Specifically, as shown in FIGS. 1A and 1B, since a main beam (signal light) and sub beams (signal light) are converged on the anamorphic lens 115, the irradiation areas of the main beam (signal light) and the sub beams (signal light) on the polarization diffraction element 116 are set to a relatively small area. On the other hand, since a main beam (stray light) and sub beams (stray light) reflected on an adjacent recording layer are in a defocused state on BD, the irradiation areas of the main beam (stray light) and the sub beams (stray light) on the polarization diffraction element 116 are set to a relatively large area.

In view of the above, setting the diffraction area 116a slightly larger than the irradiation areas of a main beam (signal light) and sub beams (signal light) is advantageous in guiding the main beam (signal light) and the sub beams (signal light) to the BD sensor pattern 117b, while keeping the outer peripheral parts of a main beam (stray light) and sub beams (stray light) from being incident onto the BD sensor pattern 117b.

As shown in FIG. 4C, the diffraction area 116a may be increased to such an extent that at least a main beam (stray light) and sub beams (stray light) reflected on an adjacent recording layer are not overlapped with each other on the four-divided sensors. In FIG. 4C, a part of the main beam spot SM2 and a part of the sub beam spots SB2 are overlapped with each other. Alternatively, the dimensions of the diffraction area 116a may be defined in such a manner that the main beam spot SM2 and the sub beam spots SB2 are not completely overlapped with each other.

As described above, in the embodiment, a main beam (stray light) and sub beams (stray light) reflected on an adjacent recording layer of BD are not overlapped with each other on each of the four-divided sensors constituting the BD sensor pattern 117b. Accordingly, there is no likelihood that an interference fringe resulting from these stray light may be formed on the four-divided sensors. This arrangement enables to suppress degradation of the quality of a servo signal and a reproduction RF signal by an interference fringe.

In addition to the above advantage, the polarization diffraction element 116 is operable to separate an optical path of BD laser light and an optical path of HD laser light from each other. Thereby, the polarization diffraction element 116 is usable both as optical path separating means and stray light suppressing means. In other words, in the embodiment, a single diffraction element is operable to separate optical paths of BD laser light and HD laser light from each other, while suppressing an interference fringe on the BD sensor pattern 117b.

In the embodiment, as shown in FIG. 4A, a main beam (stray light) and sub beams (stray light) reflected on an adjacent track are overlapped with each other on the three four-divided sensors constituting the HD sensor pattern 117a. As a result, an interference fringe resulting from these stray light may be formed on the four-divided sensors, and an output signal from the four-divided sensors may be affected by the interference fringe.

However, as a result of investigation by the inventor, it was confirmed that an interference fringe on the HD sensor pattern 117a is significantly smaller in pitch than an interference fringe on the BD sensor pattern 117b. It is conceived that the pitch difference results from a difference in the size of a focus spot on a disc, the configuration of a disc, or a like factor. In the case where the pitch is small, plural interference fringes may be formed on one four-divided sensor. Accordingly, it is presumed that influences of the interference fringes to the output signal from the sensor are cancelled with each other, with the result that the degree of degradation of signal quality as a whole is decreased, as compared with the case of the BD sensor pattern 117b.

Because of the above reason, in the embodiment, the signal quality degradation is negligibly small to such an extent that a recording/reproducing operation is executable, even if an interference fringe is formed on the four-divided sensors constituting the HD sensor pattern 117a.

The embodiment of the invention has been described as above, but the invention is not limited to the foregoing embodiment. The embodiment of the invention may be changed or modified in various ways according to needs, other than the above.

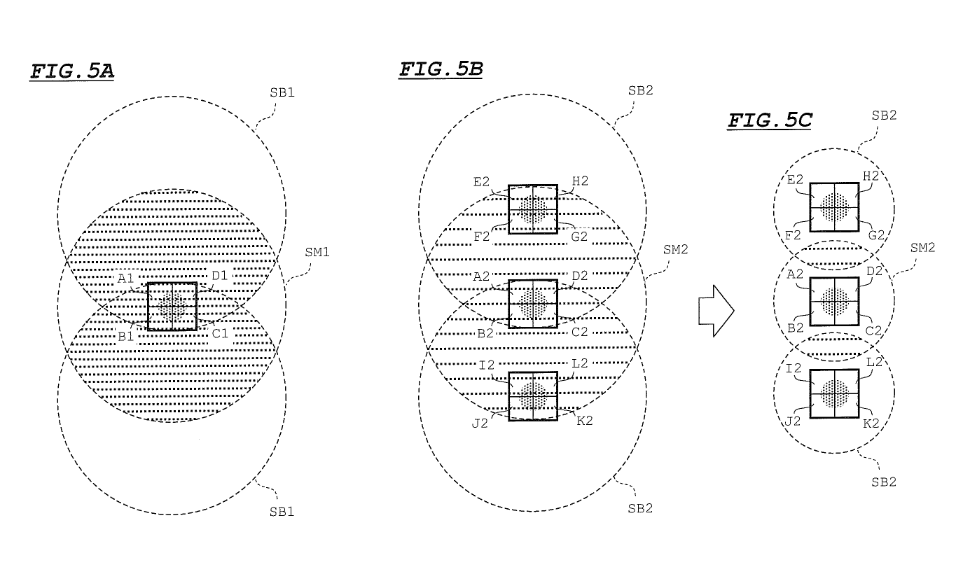

For instance, in the embodiment, both of the HD sensor pattern 117a and the BD sensor pattern 117b are a sensor pattern in accordance with a differential push-pull method using three beams. Alternatively, for instance, in the case where a reproducing operation is performed solely from HD, as shown in FIG. 5A, the HD sensor pattern 117a may be configured into a sensor pattern in accordance with a one-beam push-pull method. In the modification, similarly to the embodiment, because of the construction of the optical system, a main beam (stray light) and a sub beam (stray light) reflected on an adjacent recording layer are irradiated onto the HD sensor pattern 117a, and an interference fringe is formed on a four-divided sensor. However, since the intensity of a main beam (signal light) reflected on a targeted recording layer to be reproduced is sufficiently large, as compared with the intensity of the main beam (stray light) and the sub beam (stray light) reflected on the adjacent recording layer, the influence of the interference fringe to a servo signal is significantly reduced, even if the interference fringe is formed on the four-divided sensor, as described above.

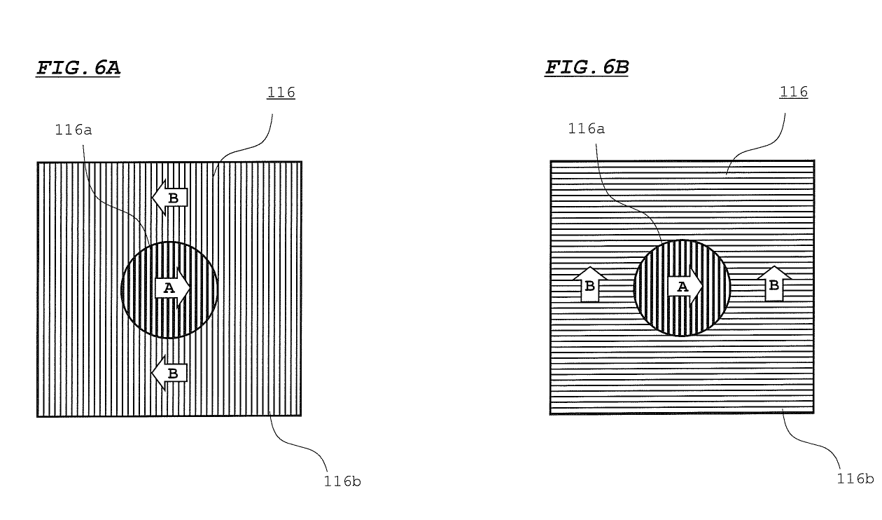

In the embodiment, a diffraction structure is not formed on the outer peripheral area 116b shown in FIG. 2A. Alternatively, for instance, as shown in FIGS. 6A and 6B, a diffraction structure operable to diffract BD laser light in a direction (shown by the arrow A in FIGS. 6A and 6B) toward the BD sensor pattern 117b may be formed on the diffraction area 116a; and a diffraction structure operable to diffract BD laser light in a direction (shown by the arrow B in FIGS. 6A and 6B) away from the BD sensor pattern 117b may be formed on the outer peripheral area 116b. The modification is further advantageous in suppressing incidence of BD laser light reflected on an adjacent recording layer onto the BD sensor pattern 117b, and reducing the distance between the HD sensor pattern and the BD sensor pattern.

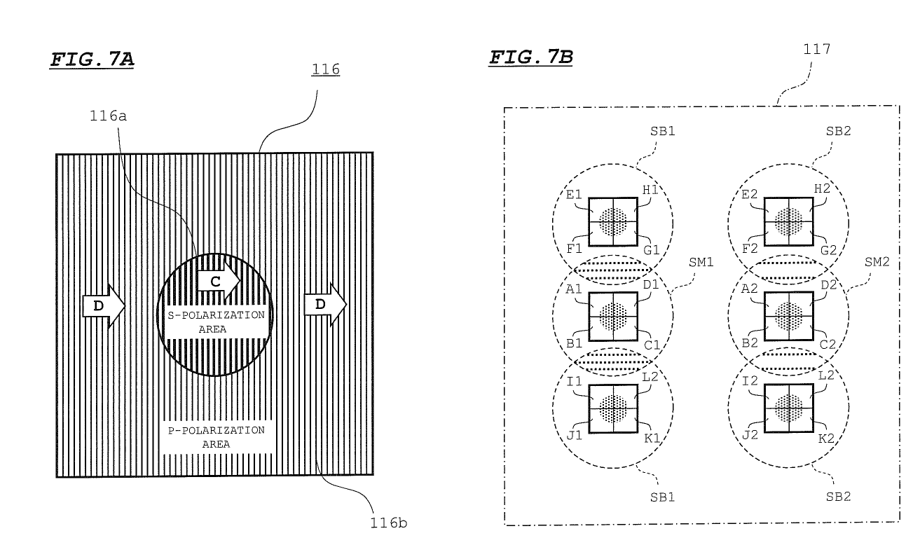

In the embodiment, solely the BD laser light (S-polarized light) is diffracted. Alternatively, for instance, as shown in FIG. 7A, a diffraction structure operable to diffract BD laser light (S-polarized light) in a direction (shown by the arrow C in FIG. 7A) toward the BD sensor pattern 117b may be formed on the diffraction area 116a; and a diffraction structure operable to diffract HD laser light (P-polarized light) in a direction (shown by the arrow D in FIG. 7A) away from the HD sensor pattern 117a may be formed on the outer peripheral area 116b. The modification is advantageous in preventing incidence of an outer peripheral part of HD laser light (stray light) reflected on an adjacent recording layer onto the HD sensor pattern 117a.

The diffraction structure of the outer peripheral area 116b may be formed by setting the refractive indexes of the blazed diffraction structure 202 shown in FIG. 2B to satisfy: np≠n1, ns=n1. In the modification, similarly to the embodiment, np and ns are refractive indices of the blazed diffraction structure 202 in the case where laser light is P-polarized light and S-polarized light, respectively, and n1 is a refractive index of glass.

FIG. 7B is a diagram schematically showing an irradiation state of stray light on a sensor pattern. In this arrangement, as shown in FIG. 7B, the irradiation areas of a main beam (stray light) and sub beams (stray light) are not overlapped with each other not only on four-divided sensors constituting a BD sensor pattern, but also on four-divided sensors constituting an HD sensor pattern. Accordingly, there is no likelihood that an interference fringe resulting from stray light may be formed on any of the four-divided sensors. The modification is advantageous in suppressing an influence of an interference fringe not only to a servo signal and a reproduction RF signal in recording and reproducing on and from BD, but also to a servo signal and a reproduction RF signal in recording and reproducing on and from HD.

In the embodiment, BD laser light is diffracted by the polarization rotating element 116 to guide the diffracted BD laser light to the BD sensor pattern 117b. Alternatively, HD laser light may be diffracted by the polarization rotating element 116 to guide the diffracted HD laser light to the HD sensor pattern 117a. In the modification, the arranged position of the HD sensor pattern 117a and the arranged position of the BD sensor pattern 117b shown in FIGS. 3A through 3D are reversed to each other.

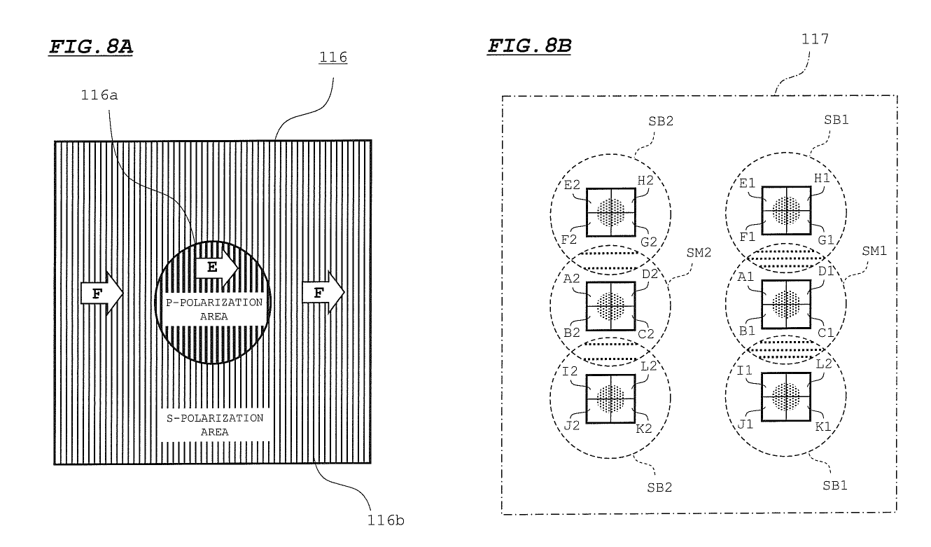

FIG. 8A is a diagram schematically showing an arrangement example of the polarization rotating element 116 in the above modification. In the modification, a diffraction structure for diffracting HD laser light (P-polarized light) in a direction (shown by the arrow E in FIG. 8A) toward the HD sensor pattern 117a is formed on the diffraction area 116a; and a diffraction structure for diffracting BD laser light (S-polarized light) in a direction (shown by the arrow F in FIG. 8A) away from the BD sensor pattern 117b is formed on the outer peripheral area 116b.

As shown in FIG. 8B, the modification enables to keep an irradiation area SM2 of a main beam (stray light) and irradiation areas SB2 of sub beams (stray light) reflected on an adjacent recording layer of BD from being overlapped with each other on the four-divided sensors constituting the BD sensor pattern 117b; and keep an irradiation area SM1 of a main beam (stray light) and irradiation areas SB1 of sub beams (stray light) reflected on an adjacent recording layer of HD from being overlapped with each other on the four-divided sensors constituting the HD sensor pattern 117a. This enables to prevent forming an interference fringe on any of the four-divided sensors. Thus, the arrangement is advantageous in suppressing degrading the quality of a servo signal and a reproduction RF signal in both of the cases of recording and reproducing on and from BD, and recording and reproducing on and from HD.

The invention is not limited to an optical pickup device compatible with BD and HD, but may be applied to an optical pickup device of a method other than the above, as necessary. In the embodiment, a blazed diffraction element having a polarization dependency is employed. In the case where a high diffraction efficiency is not required, a stepped diffraction element may be employed. In the case where the wavelengths to be used in the discs to be recorded/reproduced are different from each other, a diffraction element having a wavelength dependency may be employed, in place of a diffraction element having a polarization dependency.

The embodiment of the present invention may be changed or modified in various ways according to needs, as far as such changes and modifications do not depart from the scope of the present invention hereinafter defined.

What is claimed is:

1. An optical pickup device, comprising:
a light source for emitting laser light;
a diffraction grating for separating the laser light into a main beam and two sub beams;
an objective lens for irradiating the main beam and the sub beams onto a recording medium having multiple laminated recording layers;
a photodetector having a sensor pattern for receiving the main beam and the sub beams reflected on the recording medium respectively individually; and
a diffraction element for positioning the main beam and the sub beams reflected on a targeted recording layer to be irradiated on the sensor pattern, and diffracting the main beam and the sub beams reflected on a recording layer other than the targeted recording layer to be irradiated in such a manner that the main beam and the sub beams are not overlapped with each other on the sensor pattern.

2. The optical pickup device according to claim 1, wherein
the diffraction element is operable to change propagating directions of inner peripheral parts of the main beam and the sub beams incident onto the diffraction element in a direction toward the photodetector by a diffracting operation of the diffraction element.

3. The optical pickup device according to claim 1, wherein
the diffraction element is operable to change propagating directions of outer peripheral parts of the main beam and the sub beams incident onto the diffraction element in a direction away from the photodetector by a diffracting operation of the diffraction element.

4. An optical pickup device, comprising:
a light source for emitting laser light;
a diffraction grating for separating the laser light into a main beam and two sub beams;
a polarized beam splitter for separating an optical path of the main beam and the sub beams into an optical path of a first main beam and a first sub beam having a first polarization direction, and an optical path of a second main beam and a second sub beam having a second polarization direction orthogonal to the first polarization direction;
a first objective lens for irradiating the first main beam and the first sub beam onto a first recording medium having multiple laminated recording layers;
a second objective lens for irradiating the second main beam and the second sub beam onto a second recording medium;
a first photodetector having a first sensor pattern for receiving the first main beam and the first sub beam reflected on the first recording medium respectively individually;
a second photodetector having a second sensor pattern displaced in a direction parallel to a light receiving plane of the first sensor pattern, and adapted for receiving the second main beam and the second sub beam reflected on the second recording medium respectively individually; and
a diffraction element having a polarization dependency and adapted for making propagating directions of the first main beam and the first sub beam different from propagating directions of the second main beam and the second sub beam in such a manner that the first main beam and the first sub beam are received on the first sensor pattern, and the second main beam and the second sub beam are received on the second sensor pattern, wherein
the diffraction element is configured in such a manner that the first main beam and the first sub beam reflected on a targeted recording layer to be irradiated of the recording layers of the first recording medium are positioned on the first sensor pattern, and the first main beam and the first sub beam reflected on a recording layer other than the targeted recording layer to be irradiated are not overlapped with each other on the first sensor pattern.

5. The optical pickup device according to claim 4, wherein
the diffraction element is operable to change propagating directions of inner peripheral parts of the first main beam and the first sub beam incident onto the diffraction element in a direction toward the first photodetector by a diffracting operation of the diffraction element.

6. The optical pickup device according to claim 5, wherein
the diffraction element is operable to change propagating directions of outer peripheral parts of the second main beam and the second sub beam incident onto the diffraction element in a direction away from the second photodetector by a diffracting operation of the diffraction element.

7. The optical pickup device according to claim 4, wherein
the diffraction element is operable to change propagating directions of outer peripheral parts of the first main beam and the first sub beam incident onto the diffraction element in a direction away from the first photodetector by a diffracting operation of the diffraction element.

8. The optical pickup device according to claim 7, wherein
the diffraction element is operable to change propagating directions of inner peripheral parts of the second main beam and the second sub beam incident onto the diffraction element in a direction toward the second photodetector by a diffracting operation of the diffraction element.
